(19) United States
(12) Patent Application Publication
(10) Pub. No.: US 2026/0063233 A1
(43) Pub. Date: Mar. 5, 2026

(54) MULTI-AXIS COMPENSATOR AND VACUUM ARRANGEMENT

(71) Applicant: VON ARDENNE Asset GmbH & Co. KG, Dresden (DE)

(72) Inventor: Uwe Wehner, Lohmen (DE)

(21) Appl. No.: 19/313,321

(22) Filed: Aug. 28, 2025

(30) Foreign Application Priority Data
Aug. 29, 2024 (DE) 10 2024 124 636.7

(51) Int. Cl. F16L 51/03

(52) U.S. Cl. CPC F16L 51/03

(57) ABSTRACT

According to various embodiments, a multi-axis compensator comprises: a first mounting device and a second mounting device; a passage which penetrates the first mounting device and the second mounting device along a compensator axis; multiple membrane bellows disposed one behind the other along the compensator axis, of which a first membrane bellows is coupled to the first mounting device and a second membrane bellows is coupled to the second mounting device; at least one bellows coupler which couples the first membrane bellows to the second membrane bellows in such a way that the first membrane bellows and the second membrane bellows run at an angle to each other, so that a passage through the multi-axis compensator, which is curved or angled along the compensator axis, is provided.

### CROSS-REFERENCE TO RELATED APPLICATIONS

This application claims priority pursuant to 35 U.S.C. § 119(a) to German Patent Application No. 10 2024 124 636.7, filed Aug. 29, 2024, which application is incorporated herein by reference in its entirety.

### FIELD OF THE INVENTION

Various embodiments relate to a multi-axis compensator and a vacuum arrangement.

### BACKGROUND OF THE INVENTION

Compensators are conventionally used to compensate for movement between interconnected devices, e.g., pipes, machines, etc. The movement between the devices (relative movement) may be caused by thermal expansion, pressure deformation, mass forces, mounting misalignment, or foundation settlement. The same applies to assembly tolerances, which cause misalignment of the devices, e.g., their mounting axes, relative to each other.

According to various embodiments, it has been illustratively recognized that the membrane bellows of a conventional compensator is susceptible to the torque to which it is exposed. Illustratively, the cylindrical geometry of the membrane bellows inhibits its ability to twist, so that even a slight angular misalignment leads to damage to the compensator. Improvements in this regard, e.g., stability and/or axial compensation, are often costly.

### SUMMARY OF THE INVENTION

Various embodiments provided herein address this dilemma.

Various examples and aspects thereof are described below, which relate to what is described herein and shown in the figures.

Example 1 is configured according to one of the accompanying claims and/or is a multi-axis compensator comprising: several (e.g., end-face and/or annular) mounting devices (e.g., flanges), e.g., a first (e.g., end-face and/or annular) mounting device (e.g., a first flange) and/or a second (e.g., end-face and/or annular) mounting device (e.g., a second flange); multiple (e.g., a plurality of) membrane bellows, e.g., a first membrane bellows (e.g., diaphragm bellows) and/or a second membrane bellows (e.g., diaphragm bellows); and one or more bellows couplers, comprising: at least one (i.e., one or more) bellows coupler (also referred to as a third bellows coupler), by which the first membrane bellows is coupled to the second membrane bellows; an optional first bellows coupler, by which the first membrane bellows is coupled to the first mounting device; an optional second bellows coupler, by which the second membrane bellows is coupled to the second mounting device. The membrane bellows may, according to some aspects, be disposed in succession along the compensator axis (e.g., one behind the other along the compensator axis).

Example 2 (e.g., a multi-axis compensator) is configured according to Example 1, further comprising a holding device by which the or each third bellows coupler: is held, e.g., is held deflected (e.g., displaced) and/or is held relative to the compensator axis and/or is held in a supporting manner, e.g., on one or more of the following: at least one (e.g., the first and/or second) mounting device and/or at least one (e.g., the first and/or second) bellows coupler.

Example 3 (e.g., a multi-axis compensator) is configured according to Example 2, wherein the holding device, e.g., per third bellows coupler, has a (e.g., eccentric) holding ring, which preferably engages positively with the third bellows coupler, e.g., in a (e.g., circumferential) groove of the third bellows coupler.

Example 4 (e.g., a multi-axis compensator) is configured according to one of examples 1 to 3, wherein the holding device has an elastomer which is arranged between the holding ring and the third bellows coupler.

Example 5 (e.g., a multi-axis compensator) is configured according to one of examples 1 to 4, wherein the holding device has a frame by which the third bellows coupler is coupled to (and/or fastened to) one or more of the following: at least one (e.g., the first and/or second) mounting device and/or at least one (e.g., the first and/or second) bellows coupler.

Example 6 (e.g., a multi-axis compensator) is configured according to one of examples 1 to 5, wherein the third bellows coupler is rotatably mounted relative to the holding device, e.g., by a slide bearing.

Example 7 (e.g., a multi-axis compensator) is configured according to one of examples 1 to 6, wherein one or more of the multiple bellows couplers (e.g., at least the third bellows coupler) has two annular connecting surfaces which are opposite each other and which are inclined (e.g., wedge-shaped) to each other.

Example 8 (e.g., a multi-axis compensator) is configured according to one of examples 1 to 7, wherein the first mounting device is penetrated along the compensator axis by a first through-opening; and/or wherein the compensator axis passes through a geometric center of the first through-opening of the first mounting device.

Example 9 (e.g., a multi-axis compensator) is configured according to one of examples 1 to 8, wherein the second mounting device is penetrated along the compensator axis by a second through-opening; and/or wherein the compensator axis passes through a geometric center point of the second through-opening of the second mounting device.

Example 10 (e.g., a multi-axis compensator) is configured according to one of examples 1 to 9, wherein the first mounting device and/or the second mounting device are wedge-shaped.

Example 11 (e.g., a multi-axis compensator) is configured according to one of examples 1 to 10, further comprising a third membrane bellows, wherein the at least one third bellows coupler comprises two third bellows couplers which are coupled to one another by the third membrane bellows. This improves the compensation of torsion of the multi-axis compensator. The two third bellows couplers may couple the first membrane bellows to the second membrane bellows by the third membrane bellows.

Example 12 (e.g., a multi-axis compensator) is configured according to one of examples 1 to 11, wherein the first membrane bellows and the at least one third bellows coupler are coupled together in a material-locking manner.

Example 13 (e.g., a multi-axis compensator) is configured according to one of examples 1 to 12, wherein the first membrane bellows and the first mounting device are coupled together in a form-fitting manner.

Example 14 (e.g., a multi-axis compensator) is configured according to one of examples 1 to 13, wherein the second membrane bellows and the at least one third bellows coupler are coupled together in a material-locking manner.

Example 15 (e.g., a multi-axis compensator) is configured according to one of examples 1 to 14, further comprising: a first pipe connection, by which the first mounting device is coupled to the first bellows coupler; and/or a second pipe connection, by which the second mounting device is coupled to the second bellows coupler.

Example 16 (e.g., a vacuum arrangement) is configured in accordance with one of examples 1 to 15, further comprising: a first vacuum chamber housing to which the first mounting device is attached; a second vacuum chamber housing to which the second mounting device is attached and which is preferably arranged at a distance from the first vacuum chamber housing, wherein the first vacuum chamber housing and the second vacuum chamber housing are preferably arranged to be vacuum-tight and/or movable relative to each other by the multi-axis compensator.

Example 17 (e.g., a vacuum arrangement) is configured according to one of examples 1 to 16, further comprising: a frame by which the first vacuum chamber housing and/or the second vacuum chamber housing are supported on a base, wherein the frame has an (e.g., electromechanical) actuator by which the first vacuum chamber housing and the second vacuum chamber housing may be moved (e.g., rotated) relative to each other about the compensator axis. For example, the actuator may be configured to be actuated (e.g., controlled) in response to a signal to transmit a force between the first and second vacuum chambers and/or the frame, which causes them to move relative to each other.

Example 18 (e.g., a vacuum arrangement) is configured according to one of examples 1 to 17, further comprising: a radiation source which is arranged and/or configured in the first vacuum chamber housing to emit electromagnetic radiation along the compensator axis.

Example 19 (e.g., a vacuum arrangement) is configured according to one of examples 1 to 18, further comprising: a radiation receiver (e.g., a substrate holder) which is arranged and/or configured in the second vacuum chamber housing to receive electromagnetic radiation along the compensator axis. The substrate holder is, for example, configured to hold a substrate which is to be processed by the electromagnetic radiation.

Example 20 (e.g., a multi-axis compensator) is configured according to one of examples 1 to 19, wherein the first mounting device is disposed on a first end face of the multi-axis compensator; and/or wherein the second mounting device is disposed on a second end face of the multi-axis compensator opposite the first end face.

Example 21 (e.g., a multi-axis compensator) is configured according to one of examples 1 to 20, wherein the first mounting device is flange-shaped; and/or wherein the second mounting device is flange-shaped.

Example 22 (e.g., a multi-axis compensator) is configured according to one of examples 1 to 21, wherein the first membrane bellows is arranged between the first mounting device and the second mounting device.

Example 23 (e.g., a multi-axis compensator) is configured according to one of examples 1 to 22, wherein the third membrane bellows or each third membrane bellows is arranged between the first mounting device and the second mounting device.

Example 24 (e.g., a multi-axis compensator) is configured according to one of examples 1 to 23, wherein the first mounting device and the second mounting device are rotatably configured (e.g., mounted) relative to each other.

Example 25 (e.g., a multi-axis compensator) is configured according to one of examples 1 to 24, wherein the first mounting device and/or the second mounting device are ring-shaped.

Example 26 (e.g., a multi-axis compensator) is configured according to one of examples 1 to 25, wherein the compensator axis is straight.

Example 27 (e.g., a multi-axis compensator) is configured according to one of examples 1 to 26, wherein a geometric center of the first bellows coupler is located on the compensator axis, wherein the geometric center is preferably the geometric center of a cross-sectional area (which is, for example, transverse to the axis) of a through-opening through which the first bellows coupler is penetrated along the axis.

Example 28 (e.g., a multi-axis compensator) is configured according to one of examples 1 to 27, wherein a geometric center of the second bellows coupler is located on the compensator axis, wherein the geometric center is preferably the geometric center of a cross-sectional area (which is, for example, transverse to the axis) of a through-opening through which the second bellows coupler is penetrated along the axis.

Example 29 (e.g., a multi-axis compensator) is configured according to one of examples 1 to 28, wherein a geometric center of the third bellows coupler is spaced apart from the compensator axis, wherein the geometric center is preferably the geometric center of a cross-sectional area (which is, for example, transverse to the axis) of a through-opening, from which the third bellows coupler is penetrated along the axis.

Example 30 is configured according to one of examples 1 to 29, wherein the first membrane bellows and/or the second membrane bellows are arranged between the first mounting device and the second mounting device.

Example 31 is configured according to one of examples 1 to 30, wherein the third membrane bellows are arranged between the first mounting device and the second mounting device.

Example 32 is configured according to one of examples 1 to 31, wherein the plurality of bellows couplers are arranged between the first mounting device and the second mounting device.

Example 33 is configured according to one of examples 1 to 32, wherein the multiple (e.g., third) bellows couplers are arranged offset from one another (e.g., laterally), e.g., relative to the compensator axis.

Example 34 is configured according to one of examples 1 to 33, wherein the multiple (e.g., third) bellows couplers are arranged offset along the compensator axis one behind the other.

Example 35 is configured according to one of examples 1 to 34, wherein the first mounting device has a ring (also referred to as a first mounting ring) with which, for example, the first membrane bellows is coupled (e.g., by the first bellows coupler).

Example 36 is configured in accordance with one of examples 1 to 35, wherein the second mounting device has a ring (also referred to as a second mounting ring) with which, for example, the second membrane bellows is coupled (e.g., by the second bellows coupler).

Example 37 is configured according to one of examples 1 to 36, wherein the first mounting device and the second mounting device are disposed one behind the other along the compensator axis and/or are movable relative to each other, preferably displaceable relative to each other, e.g., according to several (e.g., two or three) degrees of translational freedom, and/or preferably rotatable relative to each other (e.g., at least about the compensator axis), e.g., at least according to one or more degrees of rotational freedom.

Example 38 is configured according to one of examples 1 to 37, wherein the first membrane bellows is tubular (then also referred to as the first bellows tube), or has at least one tubular membrane, and/or is coupled to the first mounting device (e.g., by the first bellows coupler), e.g., touching it.

Example 39 is configured according to one of examples 1 to 38, wherein the second membrane bellows is tubular (also referred to as the second bellows tube) or has at least one tubular membrane and/or is coupled to the second mounting device (e.g., by the second bellows coupler), e.g., touching it.

Example 40 is configured according to one of examples 1 to 39, wherein the third membrane bellows is tubular (then also referred to as a third bellows tube) or has at least one tubular membrane.

Example 41 is configured according to one of examples 1 to 40, wherein the third bellows coupler is configured such that e.g., mounted offset relative to the compensator axis (e.g., held and/or supported on the first and/or second mounting device) such that the first membrane bellows and the second membrane bellows run at an angle to each other and/or at an angle to the compensator axis.

Example 42 is configured according to one of examples 1 to 41, wherein the at least one third bellows coupler is (e.g., displaced) relative to the compensator axis (e.g., spatially).

Example 43 is configured according to one of examples 1 to 42, wherein a rotational movement (e.g., about the compensator axis) of the first mounting device relative to the second mounting device (e.g., causing torsion of the multi-axis compensator) is absorbed by a (e.g., helical) curvature of the first membrane bellows and/or the second membrane bellows.

Example 44 is configured according to one of examples 1 to 43, wherein the first membrane bellows has a tubular (e.g., cylindrical) membrane (also referred to as a wall); and/or wherein the second membrane bellows has a tubular (e.g., cylindrical) membrane (also referred to as a wall); and/or wherein the third membrane bellows has a tubular (e.g., cylindrical) membrane (also referred to as a wall).

Example 45 is configured according to one of examples 1 to 44, wherein the multi-axis compensator provides a hollow (e.g., cylindrical) connecting channel (e.g., configured for a line of sight), e.g., along the compensator axis and/or in which, for example, the compensator axis runs. The connecting channel may, for example, have a diameter of more than approximately 1 cm (centimeter), e.g., approximately 2 cm, e.g., approximately 5 cm, e.g., approximately 10 cm. This facilitates the emission of electromagnetic radiation through the multi-axis compensator.

Example 46 is configured according to one of examples 1 to 45, wherein the compensator axis intersects a symmetry axis of the first mounting device and/or a symmetry axis of the second mounting device.

Example 47 is configured according to one of examples 1 to 46, wherein an odd (e.g., curved or angled) passage (hereinafter also referred to as the compensator interior) is provided through the multi-axis compensator along the compensator axis. The passage may, for example, run along an uneven (e.g., curved or angled) path and/or adjoin the membrane of each bellows coupler.

Example 48 is configured according to one of examples 1 to 47, wherein a distance between the two third bellows couplers is set invariably by the holding device; and/or wherein the two third bellows couplers are held at a distance from each other by the holding device (e.g., are spatially separated from each other).

Example 49 is configured according to one of examples 1 to 48, wherein the two third bellows couplers are held spatially separated from each other by the holding device.

Example 50 is configured according to one of examples 1 to 49, wherein the two third bellows couplers are (e.g., displaced) in a direction transverse to the compensator axis and/or away from each other.

Example 51 is configured according to one of examples 1 to 50, further comprising a passage which: penetrates the first mounting device and/or the second mounting device along the compensator axis, penetrates the membrane bellows along the compensator axis and/or penetrates the or each bellows coupler along the compensator axis.

Example 52 is configured in accordance with one of examples 1 to 51, wherein the passage is bounded and/or surrounded by each of the membrane bellows (e.g., toward the outside) and/or runs unevenly.

Example 53 is configured according to one of examples 1 to 52, wherein the third bellows coupler is (e.g., displaced) relative to the compensator axis (e.g., spatially) from its rest position, e.g., by the holding device and/or against a restoring force.

Example 54 is configured in accordance with one of examples 1 to 53, wherein one or more (e.g., the first and/or second) membrane bellows of the membrane bellows has an elastomer (e.g., a wall thereof) and/or multiple (e.g., a plurality of) (e.g., annularly circumferential) protrusions (e.g., bellows waves or bellows folds).

Example 55 is configured according to one of examples 1 to 54, wherein one or more (e.g., the first and/or second) membrane bellows of the membrane bellows are configured to counteract a bending elongation (also referred to as bending) with less resistance (e.g., restoring force per elongation) than a torsional bending (also referred to as torsion). The torsion of the membrane bellows may correspond to a rotational movement (rotation) of the two bellows couplers (e.g., about the compensator axis) which are coupled to each other by the membrane bellows. The curvature of the membrane bellows can, for example, correspond to a displacement (translation) of the two bellows couplers, which are coupled to each other by the membrane bellows, relative to each other (e.g., along or across the compensator axis).

Example 56 is configured according to one of examples 1 to 55, wherein one or more (e.g., the first and/or second) membrane bellows of the membrane bellows allow damage-free torsion about the compensator axis (e.g., without tearing) of less than approximately 10°, e.g., approximately 5°, e.g., approximately 1°, e.g. approximately 0.5°.

Example 57 is configured according to one of examples 1 to 56, wherein a rotational movement of the first mounting device relative to the second mounting device by an angle (also referred to as the torsion angle Ω) which is, for example, greater than 10°, causes a torsion of each membrane bellows of less than approximately 5° (or k°), e.g., of less than approximately 1°, e.g., as approximately 0.5°, e.g., as approximately 0.1°. Alternatively, or additionally, the torsion α₍ₖ₎ of each membrane bellows k may be less than the torsion angle divided by the number N of membrane bellows of the multi-axis compensator (k=1 . . . N). For example, αₖ=10^{-p}·Ω/N, where p≥1, e.g., p≥2, e.g., p≥5.

Example 58 is configured according to one of examples 1 to 57, wherein the at least one third bellows coupler has one or more bellows couplers.

Example 59 is configured according to one of examples 1 to 58, wherein, of the at least one third bellows coupler (also referred to as inner bellows coupler), each inner bellows coupler is adjacent to two membrane bellows of the plurality of membrane bellows, which are coupled to one another by the bellows coupler (which is arranged between them, for example). The two-membrane bellows may have an inner membrane bellows and additionally have the first membrane bellows or the second membrane bellows. Alternatively, the two-membrane bellows may have two inner membrane bellows.

Example 60 is configured according to one of examples 1 to 59, wherein the inner bellows coupler is mounted (e.g., held and/or supported on the first and/or second mounting device) offset relative to the compensator axis such that the two of the membrane bellows which are adjacent to the inner bellows coupler run at an angle to each other.

Example 61 is configured according to one of examples 1 to 60, wherein the compensator axis is straight.

Example 62 is configured according to one of examples 1 to 61, wherein a first extension (e.g., length) of one or more (e.g., each) of the membrane bellows along the compensator axis is greater than a second extension (e.g., width and/or diameter) of the membrane bellows (e.g., its cavity) transverse to the compensator axis. The second extension can, for example,

Example 63 is configured according to one of examples 1 to 62, wherein the membrane bellows are arranged at an (e.g., obtuse) angle to each other, which may, for example, be less than approximately 30° (or 20° or 10°) and/or be in a range of approximately 2° to approximately 30° (or 20° or 10°).

Example 64 is configured according to one of examples 1 to 63, wherein the multiple membrane bellows comprise one or more than one pair of membrane bellows immediately adjacent to each other, between each pair of which a bellows coupler is arranged which couples the membrane bellows of the pair to each other (e.g., adjacent thereto).

Example 65 is configured according to one of examples 1 to 64, wherein the plurality of membrane bellows comprise one or more pairs of membrane bellows that are directly adjacent to each other and run at an angle to each other.

Example 66 is configured according to one of examples 1 to 65, wherein each of the multiple membrane bellows is tubular.

Example 67 is configured according to one of examples 1 to 66, wherein each of the multiple membrane bellows runs along a direction along which the membrane bellows is penetrated by a cavity (also referred to as the bellows interior) and/or which is at an angle (e.g., at an angle) to the compensator axis, wherein the angle may, for example, be less than approximately 30° (or 20° or 10°) and/or may be in a range from approximately 2° to approximately 30° (or 20° or 10°).

Example 68 is configured in accordance with one of examples 1 to 67, wherein the multiple membrane bellows comprise: one or more than one pair of mutually adjacent membrane bellows, one membrane bellows of the pair extending along a direction along which the membrane bellows is penetrated by a cavity (also referred to as the bellows interior), and an additional membrane bellows of the pair extending along an additional direction along which the additional membrane bellows is penetrated by a cavity (also referred to as the bellows interior), wherein the direction and the additional direction are inclined (e.g., at an angle) to each other, wherein the angle may, for example, be less than approximately 30° (or 20° or 10°) and/or may be in a range from approximately 2° to approximately 30° (or 20° or 10°).

Example 69 is configured in accordance with one of examples 1 to 6968, wherein the holding device is configured to displace (e.g., in a constrained manner) the bellows coupler into a position (e.g., displaced) relative to the compensator axis, e.g., even if the first mounting device and the second mounting are disposed in the same position relative to the compensator axis (or at least less (e.g., displaced) from relative to the compensator axis than the bellows coupler).

Example 70 is configured in accordance with one of examples 1 to 7069, wherein the bellows coupler are held by the holding (e.g., displaced) (also referred to as a deflected position) relative to the compensator axis independently from a position of the first mounting device and the second mounting relative to the compensator axis and/or relative to each other.

Example 71 is configured in accordance with one of examples 1 to 7170, wherein the first membrane bellows is coupled to the second membrane bellows by the bellows coupler in such a way that that the first membrane bellows and the second membrane bellows run at an angle to each other, e.g., when the first mounting device and the second mounting device are disposed: parallel (e.g., co-linear) to each other and/or centric relative to the compensator axis.

Example 72 is configured in accordance with one of examples 1 to 7271, wherein a torsion (e.g., rotation around the compensator axis) of the first mounting device and the second mounting device relative to each other is converted into displacement (by change of distance) of the first mounting device and a second mounting device relative to each other, e.g., without a torsion (e.g., rotation around the compensator axis) of the bellows coupler.

Example 73 is configured in accordance with one of examples 1 to 7372, wherein a torsion (e.g., rotation around the compensator axis) of the first mounting device and a second mounting device relative to each other is converted into a deflection (e.g., displacement) of the bellows coupler relative to the compensator axis.

Example 74 is configured in accordance with one of examples 1 to 7473, wherein a torsion (e.g., rotation around the compensator axis) of the first mounting device and the second mounting device relative to each other is converted into a rotation of the bellows coupler relative to the first mounting device and/or second mounting device and/or about the compensator axis.

Example 75 is configured in accordance with one of examples 1 to 7574, wherein the at least one bellows coupler is held rotatable about the compensator axis, e.g., by the holding device and/or a slide bearing, relative to the first mounting device and/or the second mounting device.

Example 76 is configured in accordance with one of examples 1 to 7675, wherein a distance of the at least one bellows coupler from the first mounting device or from the second mounting device is invariant regarding a movement (e.g., displacement and/or rotation) of the first mounting device or from the second mounting device relative to each other.

Example 77 is configured in accordance with one of examples 1 to 7776, wherein the at least one bellows coupler is held (e.g., by the holding device) at a distance from the first mounting device or from the second mounting device, wherein the distance is invariant regarding a movement (e.g., displacement and/or rotation) of the first mounting device or from the second mounting device relative to each other.

Example 78 is configured in accordance with one of examples 1 to 7877, wherein the at least one bellows coupler is held (e.g., by the holding device) in an orientation regarding the compensator axis (e.g., perpendicular thereto), wherein the orientation is invariant regarding a movement (e.g., displacement and/or rotation) of the first mounting device or from the second mounting device relative to each other. For example, the at least one bellows coupler do not tilt relative to the compensator axis (but may rotate around the compensator axis).

Example 79 is configured in accordance with one of examples 1 to 7978, wherein the at least one bellows coupler is held (e.g., by the holding device) in a location regarding the compensator axis (e.g., perpendicular thereto), wherein the location is invariant regarding a movement (e.g., displacement and/or rotation) of the first mounting device or from the second mounting device relative to each other. For example, the at least one bellows coupler do not displace relative to the compensator axis (but may rotate around the compensator axis).

Example 80 is configured in accordance with one of examples 1 to 8079, wherein the at least one bellows is ring shaped or comprises circular outer perimeter (e.g., a surface of rotation as outer surface).

### BRIEF DESCRIPTION OF THE DRAWINGS

FIGS. 1A and B show a multi-axis compensator according to different embodiments in a schematic side view or cross-sectional view;

FIGS. 2A and B show a multi-axis compensator according to different embodiments in a schematic side view or cross-sectional view;

FIG. 3A to C show a multi-axis compensator according to different embodiments in different schematic views;

FIGS. 4, 5, and 6 each show a multi-axis compensator according to different embodiments in different schematic perspective views;

FIG. 7 shows a multi-axis compensator according to various embodiments in a schematic side view; and,

FIG. 8 shows a vacuum arrangement according to various embodiments in a schematic side view or cross-sectional view.

The following detailed description refers to the accompanying drawings, which form part of this document and illustrate specific embodiments in which the invention may be practiced. In this regard, directional terminology such as “top,” “bottom,” “front,” “rear,” “front,” “rear,” etc. is used with reference to the orientation of the figure(s) described. Since components of embodiments may be positioned in a number of different orientations, the directional terminology is for illustrative purposes only and is not in any way limiting. It is understood that other embodiments may be used, and structural or logical changes may be made without departing from the scope of the present invention. It is understood that the features of the various exemplary embodiments described herein may be combined with one another unless specifically stated otherwise. The following detailed description is therefore not to be construed as limiting, and the scope of protection of the present invention is defined by the appended claims.

Within the scope of this description, the terms “connected,” “connected,” and “coupled” are used to describe both a direct and an indirect connection (e.g., ohmic and/or electrically conductive, e.g., an electrically conductive connection), a direct or indirect connection, and a direct or indirect coupling. In the figures, identical or similar elements are given identical reference symbols where appropriate. According to various embodiments, the term “coupled”, or “coupling” may be understood in the sense of a (e.g., mechanical, hydrostatic, thermal, and/or electrical), e.g., direct or indirect, connection and/or interaction. Several elements may, for example, be coupled together along an interaction chain along which the interaction may be exchanged, e.g., a fluid (then also referred to as fluid-conducting coupled). For example, two elements coupled together may exchange an interaction with each other, e.g., a mechanical, hydrostatic, thermal, and/or electrical interaction. A coupling of several vacuum components (e.g., valves, pumps, chambers, etc.) with each other may mean that they are fluid-conducting coupled with each other.

According to various embodiments, “coupled” may be understood in the sense of a mechanical (e.g., physical or physical) coupling, e.g., by direct physical contact. A coupling may be configured to transmit a mechanical interaction (e.g., force, torque, etc.).

An assembly device is understood here to be a device that is configured for assembly, for example for assembly on a complementary assembly device (also referred to as a counter-assembly device). During assembly, several components are connected to each other (e.g., rigidly) by their assembly devices. The assembly may be (for example, exclusively) form-fitting and/or detachable. The assembly device may preferably have an (e.g., planar) assembly surface which, during assembly, rests against a complementary assembly surface of the counter-assembly device. The mounting device can, for example, have one or more (e.g., integral) mounting profiles (e.g., form-locking profiles), which are provided, for example, by an unevenness (e.g., projection or recess) of the mounting device. Examples of the mounting profile include: a thread, a groove (e.g., for receiving a key and/or dovetail groove), a locking element (e.g., a locking lug), a bayonet lock, a pin, etc. Examples of unevenness include: an opening (e.g., through opening and/or threaded hole), a bolt (e.g., a threaded bolt).

A flange-shaped mounting device (also referred to herein as a flange) may be configured as a vacuum flange. The flange may be configured for rigid and/or detachable connection to another flange. Two flanges connected to each other form a so-called flange connection. The flange may have a (e.g., flat) mounting surface. Optionally, the flange may be penetrated by an opening (also referred to as a flange opening) which is surrounded by the mounting surface, e.g., along a closed path. The flange connection may feature that two flanges are arranged with their mounting surfaces facing each other, e.g., touching each other. The flange opening of a vacuum chamber housing may open into the interior of the vacuum chamber housing, e.g., adjacent to it. Optionally, the flange may have a groove as an exemplary sealing device, which surrounds the flange opening, e.g., along the closed path surrounding the flange opening, and/or adjacent to the mounting surface. A seal may optionally be accommodated or inserted in the groove, e.g., a metal seal or a plastic seal. Optionally, the flange may have a projection that has the mounting surface. For example, the mounting surface may protrude.

Other examples of mounting devices for a multi-axis compensator are configured for welding (e.g., to a pipe or a housing wall), for screwing or for flanging, e.g., to a machine connection. For this purpose, the mounting devices may have a weld end, a flange (e.g., a flanged end), and/or a thread (e.g., a threaded nipple).

An exemplary implementation of the mounting device is configured as a coupling device, which is designed, for example, to transmit torque. A coupling device is configured to couple two components (also referred to as coupling components), one or more of which are movably mounted, for example, by a rigid, elastic, movable, and/or detachable connection between the two components. If one of the two coupling components is a bellows (e.g., a membrane bellows), the coupling device is also referred to here as a bellows coupler. The bellows coupler has, for example, a ring with which the bellows is coupled by a material-joint. The coupling device is designed, for example, to transmit torque between the two components, for example when these are set in rotation. An example implementation of the coupling device may include a clamping device, thread, teeth, or similar for connecting the two components to each other.

A material-joint is a type of connection in which two or more parts are joined together by atomic or molecular forces, e.g., due to chemical bonding (e.g., covalent bonding, ionic bonding, metallic bonding, etc.), molecular binding, cohesion, adhesion, etc. A material-joint may be provided by, as example, bonding, welding, adhering, soldering, or in a monolithic manner. An interlocking joint (also referred to as positive locking) is a type of connection in which two or more parts are joined together by blocking each other's relative movement due to their geometry. The interlocking joint may be based on the interlocking or shape matching of the involved parts, thereby blocking movement in certain (e.g., all) directions.

A tubular component (e.g., a flexible tube) whose circumferential wall (also referred to as a bellows membrane or simply a membrane) is flexible and/or elastically deformable is understood here as a membrane bellows. The membrane comprises, for example, a polymer (e.g., elastomer) (or consists thereof) and/or has protrusions, such as folds (also referred to as bellows folds) and/or corrugations (also referred to as bellows corrugations) (for example, if the membrane consists of a metal). The interior of the membrane bellows (also referred to as the bellows interior) is bounded on the opposite side by the membrane and provides a section of the passage of the multi-axis compensator. The membrane bellows may be penetrated along a direction (also referred to as the bellows direction) from the bellows interior along which the membrane bellows extends. The membrane bellows (or at least its membrane) can, for example, be a rotary body with respect to an axis running parallel to the bellows direction (e.g., axis of rotation) and/or have a rotary surface with respect to the axis, which, for example, delimits the bellows interior. Alternatively, or additionally, the geometry of the bellows interior may be rotationally symmetrical with respect to the axis running parallel to the bellows direction (e.g., axis of rotation).

According to various embodiments, a vacuum chamber may be provided by a chamber housing (then also referred to as a vacuum chamber housing) in which one or more chambers may be provided. The chamber housing can, for example, be coupled to a pump arrangement, e.g., a vacuum pump arrangement (e.g., gas-conducting), for providing a negative pressure or a vacuum (vacuum chamber housing) and be stably arranged and configured such that it may withstand the effect of air pressure in the pumped-out state. The pump arrangement (having at least one vacuum pump, e.g., a high-vacuum pump, e.g., a turbomolecular pump) may enable part of the gas to be pumped out of the interior of the processing chamber, e.g., from the processing space. Accordingly, one or more vacuum chambers may be provided in a chamber housing. In other words, the chamber housing may be configured as a vacuum chamber housing, or a coating chamber may be configured as a vacuum chamber.

The term “vacuum pressure” refers to a negative pressure in the vacuum range (i.e., a pressure of less than 0.3 bar), e.g., a pressure in a range from approximately 10 mbar to approximately 1 mbar (in other words, rough vacuum) or less, e.g., a pressure in a range from approximately 1 mbar to approximately 10−³ mbar (in other words, fine vacuum) or less, e.g., a pressure in a range of approximately 10⁻³ mbar to approximately 10−⁷ mbar (in other words, high vacuum) or less, e.g., a pressure less than high vacuum, e.g., less than approximately 10−⁷ mbar.

A drive device may be understood here as a converter which is configured to convert electrical energy into mechanical energy. A drive device may, for example, comprise an electric motor (e.g., with electric coils). A drive device may, for example, comprise a compressor and a reciprocating piston coupled thereto. A drive device may, for example, comprise one or more piezo elements. For example, the drive device may be configured to output mechanical energy by torque or rotary motion.

The spatial position is understood here as information about the spatial orientation and/or the spatial location of an object, for example, relative to one or more references (e.g., the center) of the object. The location may be specified, for example, as a coordinate point in space and the orientation as the orientation (e.g., as a direction or vector) of the object relative to the space. The location of an object can, for example, be specified as the location of the reference (e.g., the center of mass) of the object in space (then also referred to as the reference location). Alternatively, or additionally, the orientation may be specified as the relative position (e.g., as a vector) of several references of the object relative to each other. Examples of references to the object include: a center of mass of the object, one or more geometric centers of the object (e.g., of a surface thereof), one or more markings of the object, one or more edges of the object, etc. If the object has a (e.g., cylindrical) cavity, the geometric center (also referred to as center of geometry) of the cavity or at least one cross section of the cavity may be used as a reference for the object.

Reference is made here to the positions of several objects (e.g., bellows couplers) relative to each other and/or relative to an axis (e.g., compensator axis). In this regard, it may be understood that the spatial position of each of the objects is related to the same type of reference of the object, for example, to a geometric center of each of the objects. Several objects arranged offset from one another may differ from one another in their position relative to the axis, for example if the location (e.g., the geometric center) of at least two of the objects lies on the axis and/or if they coincide in their orientation relative to the axis. In this case, the location of a third object may be at a distance from the axis such that it is offset relative to the axis.

Torsion of a body (e.g., multi-axis compensator) is understood to be a deformation of the body by a rotation of two end sections of the body (e.g., two mounting devices) opposite each other along an axis (also referred to as the torsion axis, which may be, for example, the compensator axis or parallel thereto) relative to each other about the torsion axis. For example, a multi-axis compensator may exhibit torsion that causes the first mounting device and the second mounting device to rotate relative to each other about the compensator axis. For example, a membrane bellows may exhibit torsion that rotates two bellows couplers, which are adjacent to the membrane bellows and between which the membrane bellows is arranged, relative to each other (e.g., about the compensator axis). A curvature (also referred to as bending) of the body is distinguished from torsion, in which the two end sections are displaced relative to each other and/or rotated relative to each other about an axis transverse to the torsion axis.

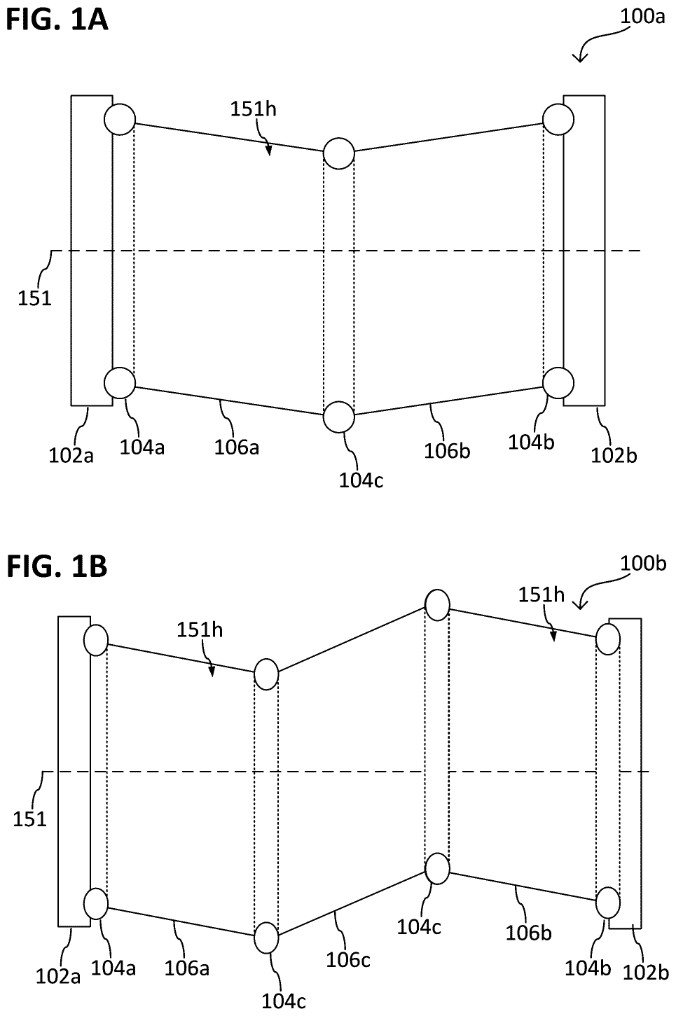

FIG. 1A illustrates a multi-axis compensator according to various embodiments 100a in a schematic side view or cross-sectional view, preferably configured according to example 1.

For ease of understanding, reference is made herein to a compensator axis 151, which passes through the geometric center as a point reference of each of the two mounting devices 102a, 102b. The point-shaped reference can, for example, be the geometric center (e.g., center point) of the cross-sectional area of the compensator interior, which is bounded on the opposite side by the mounting device. It may be understood that the above description applies analogously to any differently positioned compensator axis 151 along which the multi-axis compensator is penetrated by a cavity 151h (also referred to as the compensator interior or passage).

The compensator interior 151h extends through the components of the multi-axis compensator, e.g., through its mounting devices 102a, 102b and/or bellows couplers 104a, 104b, 104c, and is bounded on the outside by the membrane bellows 106a, 106b. The multiple bellows couplers 104a, 104b, 104c are arranged between the two mounting devices 102a, 102b of the multi-axis compensator.

Reference is made herein to an exemplary implementation of the mounting devices, which comprise a flange-shaped first mounting device 102a (also referred to as first flange 102a) and a flange-shaped second mounting device 102b (also referred to as second flange 102b), which are arranged, for example, on the end faces. The above description may be applied analogously to any other type of mounting device, which does not necessarily have to be flange-shaped.

An exemplary implementation of the first flange 102a and/or the second flange 102b of the multi-axis compensator has a ring which surrounds the compensator interior 151h. The ring also has several openings, each for receiving a screw. Alternatively, or additionally, the ring has a mounting surface which faces away from the membrane bellows 106a, 106b and has a sealing surface as an exemplary sealing device.

An exemplary implementation of the bellows couplers 104a, 104b, 104c is ring-shaped (provided, for example, as a steel ring) and disposed one behind the other along the compensator axis 151. The bellows couplers 104a have at least one (i.e., one or more) third bellows coupler 104c, each third bellows coupler 104c being spatially deflected (e.g., displaced) (also referred to as offset) relative to the compensator axis. Between the first bellows coupler 104a and the third bellows coupler 104c, at least one section of the first membrane bellows 106a is arranged in a manner that is offset relative to the compensator axis 151 (also referred to as displaced). Between the second bellows coupler 104b and the third bellows coupler 104c, at least one section of the second membrane bellows 106b is arranged.

The or each third bellows coupler 104c is arranged offset relative to the first mounting device 102a and/or the second mounting device 102b, e.g., shifted so that it is coplanar with them. Several third bellows couplers 104c are arranged offset relative to one another, e.g., shifted so that they are coplanar with one another.

This positioning of the or each third bellows coupler 104c ensures that a rotational movement of the first flange 102a relative to the second flange 102b may be absorbed by the first membrane bellows 106a and the second membrane bellows 106b being curved (e.g., helically). This reduces the mechanical stress on the first membrane bellows 106a and the second membrane bellows 106b, especially if these are not configured to absorb rotational movement.

FIG. 1B illustrates a multi-axis compensator according to various embodiments 100b in a schematic side view or cross-sectional view, preferably configured according to one of the embodiments 100a, wherein multiple (e.g., a plurality of) third bellows couplers 104c are provided. Multiple (e.g., a plurality of) third bellows couplers 104c are, for example, arranged offset relative to one another, e.g., shifted in a plane parallel to one another.

The bellows couplers 104a, 104b, 104c of embodiments 100a to 100b may be coupled to each other (e.g., rigidly and/or interlocking), for example by the flanges 102a, 102b and/or a holding device, as explained below.

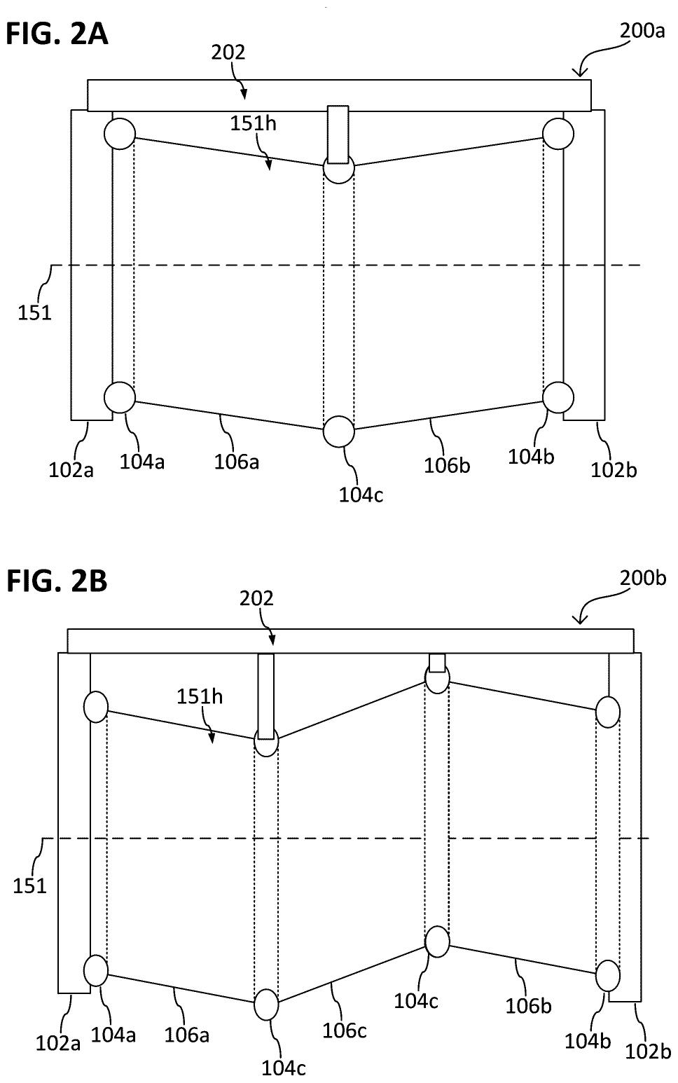

FIG. 2A illustrates a multi-axis compensator according to various embodiments 200a in a schematic side view or cross-sectional view, preferably arranged in accordance with one of embodiments 100a to 100b and/or in accordance with example 4, which further comprises a holding device 202 by which the third bellows coupler 104c is held in the deflected (e.g., displaced) position.

The holding device 202 can, for example, be rigidly coupled to the first flange 102a and/or the second flange 102b.

FIG. 2B illustrates a multi-axis compensator according to various embodiments 200b in a schematic side view or cross-sectional view, preferably configured according to one of the embodiments 200a and/or according to example 4, wherein multiple (e.g., a plurality of) third bellows couplers 104c are provided. Multiple (e.g., a plurality of) third bellows couplers 104c are, for example, arranged offset relative to one another, e.g., shifted in a plane parallel to one another.

The following refers to examples of embodiments that have two third bellows couplers 104c, whereby it may be understood that what is described here may apply analogously to embodiments with more or fewer than two third bellows couplers 104c.

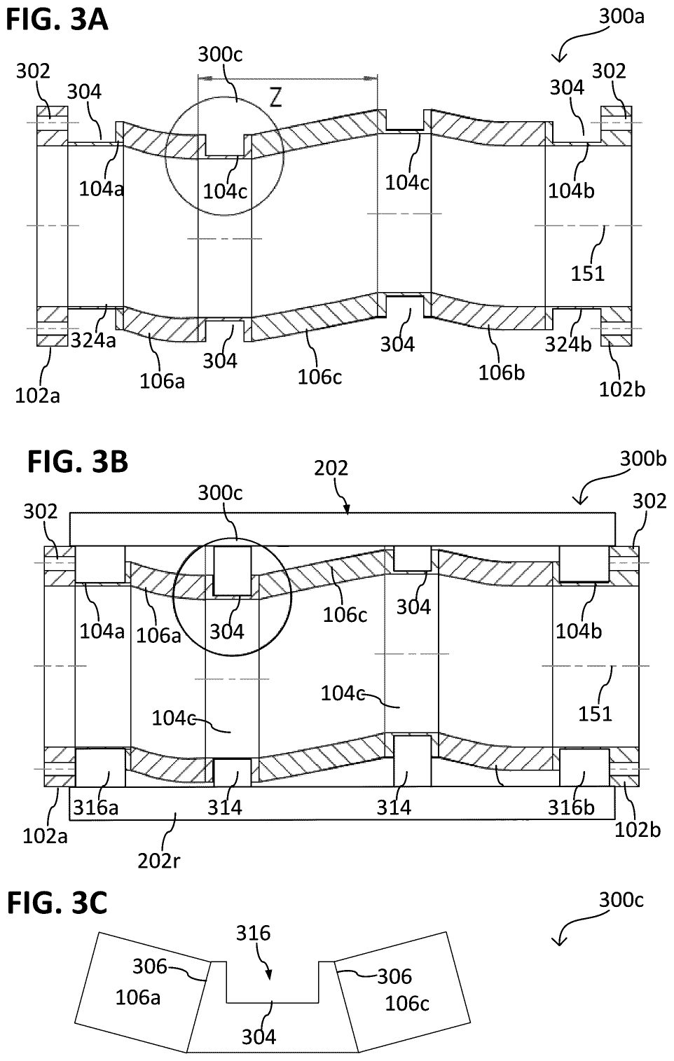

FIG. 3A illustrates a multi-axis compensator according to various embodiments 300a in a schematic side view or cross-sectional view, preferably configured according to one of the embodiments 100a to 200b and/or according to example 5.

An exemplary implementation of the first flange 102a of the multi-axis compensator has a first ring with which the first bellows coupler 104a (e.g., monolithic) and which provides a collar projecting away from the compensator axis 151, which is penetrated along the compensator axis 151 by multiple (e.g., a plurality of) through openings 302.

An exemplary implementation of the second flange 102b of the multi-axis compensator has a second ring to which the second bellows coupler 104b (e.g., monolithically) and which provides a collar projecting away from the compensator axis 151, which is penetrated along the compensator axis 151 by multiple (e.g., a plurality of) through-openings 302.

An exemplary implementation of the first, second, and/or third bellows couplers 104a, 104b, 104c has a ring in which a circumferential groove 304 is formed. For example, the ring may have a U-shaped cross-section. The groove 304 of each third bellows coupler 104c may, for example, be arranged between the first membrane bellows 106a and the second membrane bellows 106b.

An exemplary implementation (e.g., according to Example 11) of the first pipe connection 324, which couples the first flange 102a to the first bellows coupler 104a, and/or the second pipe connection 324b, which couples the second flange 102b to the second bellows coupler 104b, is configured such that it delimits or has a groove 304, which is arranged, for example, between the bellows coupler and the flange.

FIG. 3B illustrates a multi-axis compensator according to various embodiments 300b in a schematic side view or cross-sectional view, preferably configured according to one of the embodiments 300a and/or according to example 2.

An exemplary implementation of the retaining device has several holding rings (e.g., steel rings), at least one or more inner holding rings and/or one or more outer holding rings. For example, the multiple holding rings per third bellows coupler 104c have a holding ring 314 (also referred to as an inner holding ring for the sake of simplicity), each of which engages in the groove of the third bellows coupler 104c. Each inner holding ring 314 has an eccentric through-opening (also referred to as a retaining opening) in which the third bellows coupler 104c is arranged.

The eccentrically arranged retaining opening illustratively ensures that the third bellows coupler 104c is held offset relative to the compensator axis 151. In the embodiment shown, two third bellows couplers 104c are held offset from each other by the eccentrically arranged retaining openings. This favors the membrane bellows 106a, 106b, 106c (e.g., membrane springs) being aligned at different angles to each other.

Furthermore, the holding device 202 has a tubular frame 202r in which the multiple holding rings (or at least each inner holding ring 314) are arranged. The frame may be supported, for example, by one or more outer holding rings, e.g., on the first bellows coupler 104a (and/or the first pipe connection) and/or the second bellows coupler 104b (and/or the second pipe connection).

An exemplary implementation of one or more outer holding rings comprises, for the first flange 102a, a first outer holding ring 316a, which engages in the groove 304 defined by the first flange 102a and/or the first pipe connection 324a and supports the frame 202r. Alternatively or additionally, the one or more outer holding rings for the second flange 102b has a second outer holding ring 316b, which engages in the groove 304 bounded by the second flange 102b and/or second pipe connection 324b and supports the frame 202r. Each of the outer holding rings may have a concentrically arranged through-opening in which the bellows coupler is arranged. In an alternative implementation, each outer holding ring is provided monolithically with a pipe connection and/or a flange.

It may be understood that the outer holding rings are not absolutely necessary, for example if the frame 202r is fastened to the first flange 102a, the first pipe connection 324a, the second flange 102b and/or the second pipe connection 324b.

An exemplary implementation of the multiple holding rings has two half rings per holding ring, which are joined together to form the holding ring. Alternatively, or additionally, each of the holding rings may have or consist of an elastomer, e.g., polyether ether ketone (PEEK).

Optionally, each of the holding rings (or at least the inner holding rings) may be connected to the frame 202r in a rotationally secured manner so that a rotational movement of the holding ring relative to the frame 202r is blocked. Alternatively, or additionally, an elastomer (e.g., neoprene) may be arranged between each of the holding rings and the bellows coupler, in whose groove the holding ring engages, e.g., in the form of a strip. This provides a sliding bearing so that the bellows coupler is rotatably mounted within the holding ring, which improves the bearing.

FIG. 3C illustrates a multi-axis compensator according to embodiments 300a or 300b in a schematic detailed view 300c, preferably configured according to one of the embodiments and/or according to example 7 and/or example 10.

An exemplary implementation 316 of the first, second or third bellows coupler is wedge-shaped, e.g., comprising one or more planar ring surfaces (also referred to as tubular connecting surfaces) against which an end face of a membrane bellows 106a, 106c rests. This facilitates the membrane bellows (or at least its end face) being aligned at an angle to the compensator axis 151.

An exemplary implementation (not shown) of the first flange 102a and/or the second flange 102b is wedge-shaped, for example a planar ring surface (also referred to as a tubular connecting surface), against which an end face of the bellows coupler rests and which is aligned at an angle to the compensator axis 151. This favors the bellows (or at least its end face) being aligned at an angle to the compensator axis 151.

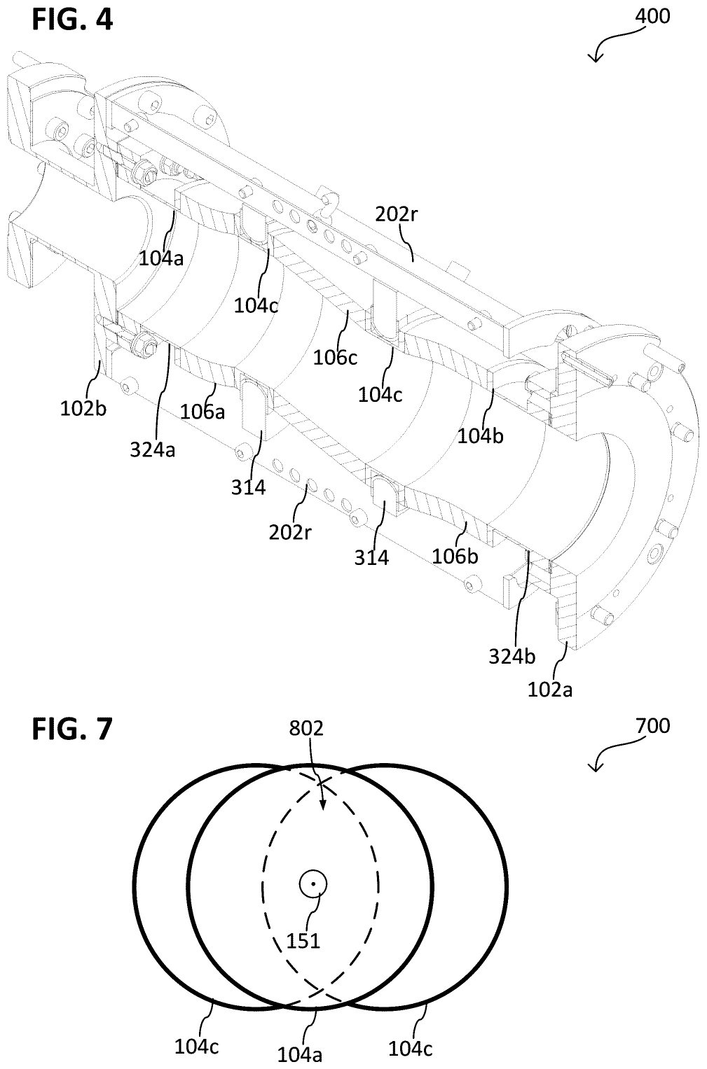

FIG. 4 illustrates a multi-axis compensator according to various embodiments 400 in a schematic sectional perspective view, preferably configured according to one of embodiments 100a to 300b and/or according to example 4. FIG. 5 illustrates the multi-axis compensator according to the embodiments 400 in a schematic perspective view 500. As may be seen, the holding device 202 may have several elongated (e.g., beam-shaped) components as a frame 202r, each component being coupled (e.g., only) to the first flange 102a or (e.g., only) to the second flange 102b.

FIG. 6 illustrates a multi-axis compensator according to various embodiments 600 in a schematic sectional perspective view, preferably configured according to one of embodiments 100a to 500b and/or according to example 4. As may be seen, the holding device 202 may comprise a tubular frame 202r (then also referred to as a compensator housing) which is coupled (e.g., only) to the first flange 102a or (e.g., only) to the second flange 102b. The membrane bellows can, for example, be arranged in the compensator housing.

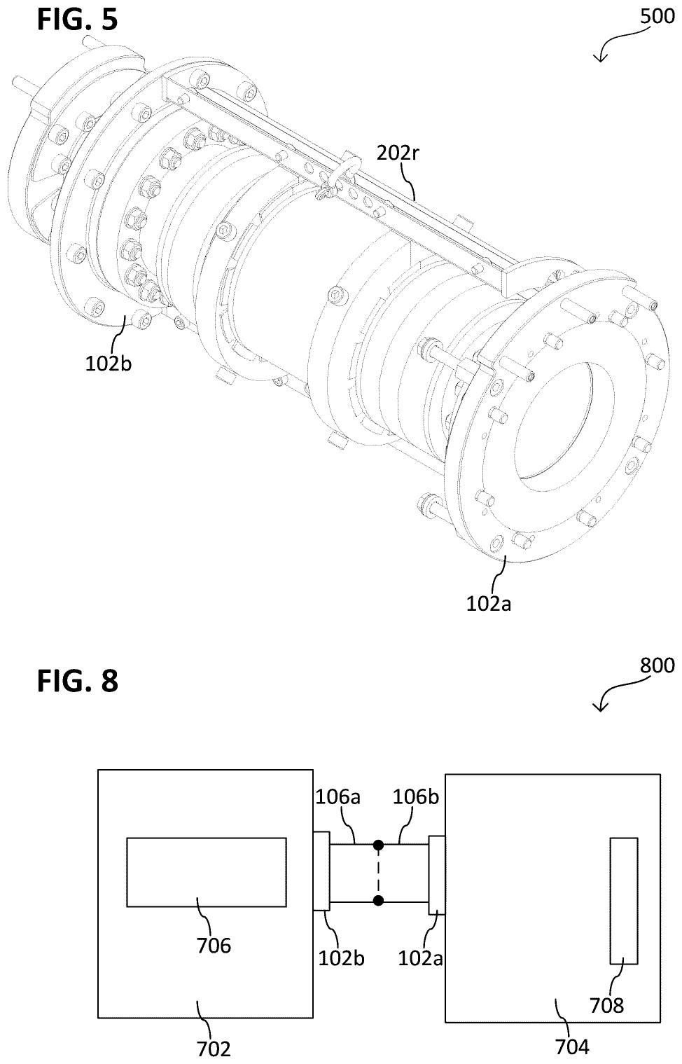

FIG. 7 illustrates a multi-axis compensator according to various embodiments 700 in a schematic top view looking along the compensator axis 151, preferably a multi-axis compensator configured according to an embodiment 700 of embodiments 100a to 600b and/or according to example 1, wherein the position of the plurality of bellows couplers relative to one another is represented by their inner contour. As shown, every third bellows coupler 104c may be arranged offset relative to the first and/or second bellows coupler 104a, 104b. For example, several third bellows couplers 104c may be deflected (e.g., displaced)toward each other opposite sides (e.g., right and left) of the compensator axis 151 and/or away from each other.

The compensator axis 151 is enclosed by a straight channel 802 (also referred to as a connecting channel), along which a line of sight may be provided through the multi-axis compensator. This makes it possible to transmit electromagnetic radiation or another straight-line propagating effect through the multi-axis compensator.

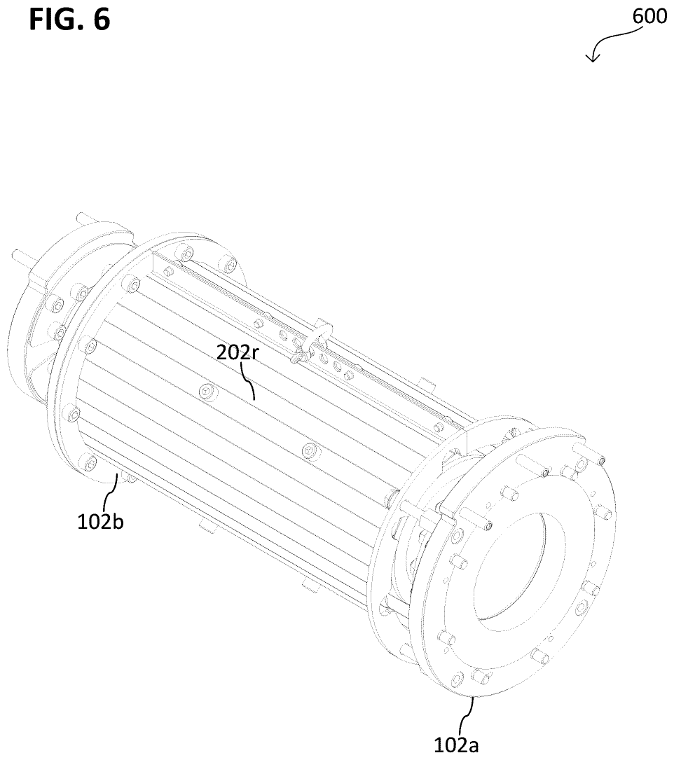

FIG. 8 illustrates a vacuum arrangement according to various embodiments 800 in a schematic sectional perspective view, which has the multi-axis compensator configured according to one of embodiments 100a to 700b and is preferably configured according to example 16.

An exemplary implementation of the multi-axis compensator provides a vacuum-tight connection between the first vacuum chamber housing 702 and the second vacuum chamber housing 704. The vacuum arrangement has several vacuum chamber housings, which have a first vacuum chamber housing 702 and a second vacuum chamber housing 704, which are spaced apart from each other. The first vacuum chamber housing 702 can, for example, be mounted independently of the second vacuum chamber housing 704. Alternatively, or additionally, the first vacuum chamber housing 702 and/or the second vacuum chamber housing 704 may be supported on a base, for example by a frame.

An exemplary implementation of the frame has a bearing device and an optional drive device as an actuator. The bearing device provides the first vacuum chamber housing 702 and/or the second vacuum chamber housing 704 with a rotational axis about which they may be rotated relative to each other. The axis of rotation can, for example, be the compensator axis 151 or at least pass through the interior of the compensator. The drive device is configured to transmit a torque to the first vacuum chamber housing 702 and/or the second vacuum chamber housing 704 in order to drive a rotational movement of the first vacuum chamber housing 702 relative to the second vacuum chamber housing 704. The rotational movement may be absorbed by the multi-axis compensator without a

An exemplary implementation of the radiation source 706 is arranged in the first vacuum chamber housing 702 and has a laser (also referred to as a laser beam source) which is configured to emit a laser beam as an exemplary electromagnetic radiation through the multi-axis compensator into the second vacuum chamber housing 704.

An exemplary implementation of the radiation receiver 708 has a substrate holder which is configured to hold a substrate in the second vacuum chamber housing 704. The laser beam is emitted, for example, along an emission axis which is directed through the compensator interior onto the radiation receiver.

1. A multi-axis compensator, comprising:
a first mounting device and a second mounting device;
a passage extending through the first mounting device and the second mounting device along a compensator axis;
multiple membrane bellows disposed in succession along the compensator axis, of which a first membrane bellows is coupled to the first mounting device and a second membrane bellows is coupled to the second mounting device;
at least one bellows coupler by which the first membrane bellows is coupled to the second membrane bellows, such that the first membrane bellows and the second membrane bellows run at an angle to each other, when the first mounting device and the second mounting device are centric to the compensator axis.

2. The multi-axis compensator according to claim 1, further comprising a holding device by which the bellows coupler is held displaced relative to the compensator axis, when the first mounting device and the second mounting device are centric to the compensator axis.

3. The multi-axis compensator according to claim 2, wherein the holding device comprises an eccentric holding ring, by which the bellows coupler is held displaced relative to the compensator axis.

4. The multi-axis compensator according to claim 43, wherein the holding ring and the bellows coupler engage positively with one another to allow a rotation of the bellows coupler relative to the holding ring around the compensator axis.

5. The multi-axis compensator according to claim 2, wherein the passage along the compensator axis runs unevenly through the multi-axis compensator, when the first mounting device and the second mounting device are centric to the compensator axis.

6. The multi-axis compensator according to claim 2, wherein the holding device is rigidly coupled to first mounting device or to the second mounting device.

7. The multi-axis compensator according to claim 76, wherein the holding device is rigidly coupled to first mounting device, and wherein the holding device is spatially separated by a gap from second mounting device to allow a movement of the second mounting device relative to the holding device.

8. The multi-axis compensator according to claim 1, wherein the at least one bellows coupler is held in a position excentric from the compensator axis independently from a position of the first mounting device and the second mounting device relative to the compensator axis or relative to each other.

9. The multi-axis compensator according to claim 1, wherein at least one of the first mounting device and the second mounting device comprises a flange.

10. The multi-axis compensator according to claim 1, wherein the first membrane bellows and the second membrane bellows are connected by the bellows coupler, such that a rotational movement of the first mounting device relative to the second mounting device around the compensator axis is absorbed by a curvature of at least one of: the first membrane bellows and the second membrane bellows.

11. The multi-axis compensator according to claim 1, wherein the bellows coupler has two annular connecting surfaces which are opposite to each other and are at an angle to each other.

12. The multi-axis compensator according to claim 1, further comprising a third membrane bellows, wherein the at least one bellows coupler comprises two bellows couplers which are coupled to each other by the third membrane bellows.

13. The multi-axis compensator according to claim 1, wherein the at least one bellows coupler is coupled by a material-joint to at least one of: the first membrane bellows and the second membrane bellows.

14. The multi-axis compensator according to claim 1, wherein the at least one bellows coupler is held rotatable about the compensator axis relative to the first mounting device or to the second mounting device.

15. The multi-axis compensator according to claim 1, wherein a torsion of the first mounting device and the second mounting device relative to each other is converted into a rotation of the bellows coupler about the compensator axis relative to the first mounting device or second mounting device.

16. The multi-axis compensator according to claim 1, wherein the at least one bellows coupler is held non-tiltable relative to the compensator axis.

17. The multi-axis compensator according to claim 1, wherein the at least one bellows coupler comprises a circular outer perimeter.

18. A vacuum arrangement comprising:
a multi-axis compensator, comprising:
a first mounting device and a second mounting device;
a passage extending through the first mounting device and the second mounting device along a compensator axis;
multiple membrane bellows disposed in succession along the compensator axis, of which a first membrane bellows is coupled to the first mounting device and a second membrane bellows is coupled to the second mounting device;
at least one bellows coupler by which the first membrane bellows is coupled to the second membrane bellows such that the first membrane bellows and the second membrane bellows run at an angle to each other, when the first mounting device and the second mounting device are centric to the compensator axis;
a first vacuum chamber housing to which the first mounting device is attached; and,
a second vacuum chamber housing to which the second mounting device is attached, and which is arranged at a distance from the first vacuum chamber housing.

19. The vacuum arrangement according to claim 1918, further comprising:
a radiation source arranged in the first vacuum chamber housing, which is configured to emit electromagnetic radiation along the compensator axis; and
a radiation receiver arranged in the second vacuum chamber housing, which is configured to receive electromagnetic radiation along the compensator axis.

20. A method for a multi-axis compensator,
the multi-axis compensator comprising:
a first mounting device and a second mounting device;
a passage extending through the first mounting device and the second mounting device along a compensator axis;
multiple membrane bellows disposed in succession along the compensator axis, of which a first membrane bellows is coupled to the first mounting device and a second membrane bellows is coupled to the second mounting device;
at least one bellows coupler by which the first membrane bellows is coupled to the second membrane bellows such that the first membrane bellows and the second membrane bellows run at an angle to each other, when the first mounting device and the second mounting device are centric to the compensator axis;
the method comprising:
forming a vacuum in the passage;
compensating a rotational movement of the first mounting device relative to the second mounting device around the compensator axis by at least one of:
a curvature of the first membrane bellows,
a curvature of the second membrane bellows, and
a rotation of the bellows coupler about the compensator axis relative to the first mounting device or second mounting device.
